(19) United States
(12) Patent Application Publication
(10) Pub. No.: US 2017/0054410 A1
(43) Pub. Date: Feb. 23, 2017

(54) MOBILE DIAGNOSIS SYSTEM FOR SOLAR POWER PLANT

(71) Applicant: Sinogreenergy Consultant Co. Ltd., Taipei City (TW)

(72) Inventor: Kun-Hong CHEN, Taipei City (TW)

(21) Appl. No.: 14/827,680

(22) Filed: Aug. 17, 2015

(51) Int. Cl. H02S 50/00; G06Q 50/06; H02J 13/00

(52) U.S. Cl. CPC H02S 50/00; H02J 13/00; G06Q 50/06

(57) ABSTRACT

A mobile diagnosis system for a solar power plant includes an image recognizing module, a database, a transmitting module, a handheld device and an operating interface. The image recognizing module is to recognize data of the solar power plant. The database is to store and organize the data. The transmitting module is to transmit the data. The handheld device is to receive the data. The operating interface is installed in the handheld device to display and compare the data. A manager can acquire different kinds of data of the solar power plant through the handheld device by the diagnosis system. The data of the solar power plant is compared with the data of adjacent and normal solar power plants or the historical data to diagnose whether the work of the solar power plant is normal.

### BACKGROUND OF THE INVENTION

1. Field of the Invention

The present invention relates to a mobile diagnosis system for a solar power plant, and more particularly to a mobile diagnosis system that a manager can acquire different kinds of required data to diagnose the solar power plant by application software (APP) of a handheld device to perform problem diagnosis through a data comparison method so as to achieve a fast and accurate diagnosis purpose.

2. Description of Related Art

Life is more and more convenient because of technology. However, high technology relies on power, and many power plants need to be built, such as a development of a nuclear power plant or a thermal power plant. In addition, with increasing environmental awareness, the number of solar power plants is gradually increased. Since the number and kinds of the solar power plants are increased, the complication and difficulty of the management and maintenance of the power plant are increased.

For example, since the locations of the solar power plants are scattered, it is impossible for the manager to stay in the solar power plants to monitor the working status of the power plants all the time. When any abnormal situation of the solar power plant occurs, lots of time has been wasted after the manager arrives at the power plant to figure out the malfunction in person. In addition, when tsunami or earthquake strikes, problems will happen to many solar power plants at the same time and the manager has to handle the maintenance in many solar power plants at the same time. The repair time of the solar power plant is delayed. Accordingly, how to speed up and gather the correct data from the problematic power plant is a challenge.

Therefore, a need arises to design a system for the manager to monitor a working status, a converting efficiency or a maintenance situation of the solar power plant at any time. In addition, different kinds of data required from the solar power plant can be gathered by APPs within the handheld devices. The data between the problematic power plant and the normal power plants or the data in the problematic power plant at different time is compared, so the manager can efficiently manage the solar power plants and the problem of the solar plants can be quickly and accurately diagnosed.

### SUMMARY OF THE INVENTION

One objective of the present invention is to provide a diagnosis system for a solar power plant. A manager is not required to stay in the solar power plant all the time and the solar power plant can be remotely diagnosed by the diagnosis system.

According to the aforementioned objective, a mobile diagnosis system for a solar power plant is provided in the present invention and comprises:

an image recognizing module configured to recognize a plurality of data of the solar power plant;

a database configured to store and organize the plurality of data;

a transmitting module configured to transmit the plurality of data;

a handheld device configured to receive the plurality of data; and

an operating interface installed in the handheld device and configured to display and compare the plurality of data to determine a working status of the solar power plant.

Another objective of the present invention is to provide a mobile diagnosis system for a solar power plant. The manager can quickly gather many different kinds of data and the power generation information of the solar power plant to determine whether the solar power plant is abnormal as soon as possible.

According to the aforementioned objective, a mobile diagnosis system for a solar power plant is provided in the present invention and comprises:

an image recognizing module configured to recognize a plurality of data of the solar power plant and including:
a design data recognizing unit configured to recognize a plurality of design and architecture data of the solar power plant;
a brand model data recognizing unit configured to recognize a brand name and model for at least one component of the solar power plant;
an ambient climate data recognizing unit configured to recognize an ambient climate data of the solar power plant;
a power generation recognizing unit configured to recognize a power generation data for the solar power plant or a plurality of power generation components of the solar power plant; and
an electronic component data recognizing unit configured to recognize a data related to component temperature, resistance or leak current of the solar power plant;

a database configured to store and organize the plurality of data;

a location detecting module configured to detect a location coordination and orientation data of the solar power plant and store the location coordination and orientation data in the database;

a transmitting module configured to transmit the plurality of data;

a handheld device configured to receive the plurality of data; and

an operating interface installed in the handheld device and configured to display and compare the plurality of data to determine a working status of the solar power plant;

wherein the plurality of data of the solar power plant is acquired by the operating interface of the handheld device and the plurality of data is compared with a plurality of raw data of a plurality of adjacent solar power plants or a historical power generation data of the solar power plant.

According to the aforementioned mobile diagnosis system for the solar power plant, the manager can acquire the data and the power generation information of the solar power plant for diagnosing the problems. By comparing the data between the aforementioned solar power plant and the adjacent solar power plants or comparing the data of the solar power plant with the historical data of the solar power plant, the manager can manage the solar power plant efficiently and diagnose the problems of the solar power plant quickly and accurately.

### BRIEF DESCRIPTION OF THE DRAWINGS

FIG. 1 is a view of a mobile diagnosis system for a solar power plant in one embodiment of the present invention;

FIG. 2 is a block diagram of an image recognizing module in the embodiment of the present invention.

### DETAILED DESCRIPTION OF THE PREFERRED EMBODIMENT

These and other aspects of the embodiments herein will be better appreciated and understood when considered in conjunction with the following description and the accompanying drawings.

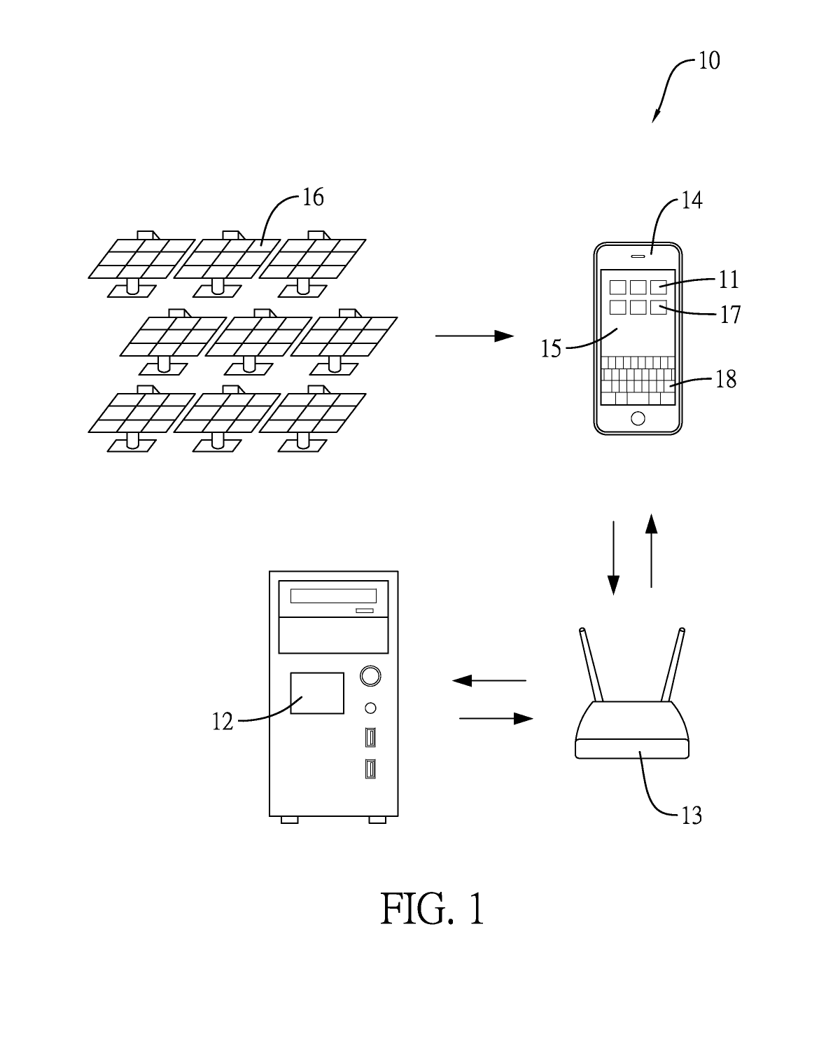

FIG. 1 is a view of a mobile diagnosis system for a solar power plant in one embodiment of the present invention. As shown in FIG. 1, the mobile diagnosis system 10 for the solar power plant 16 includes an image recognizing module 11, a database 12, a transmitting module 13, a handheld device 14 and an operating interface. 15.

The image recognizing module 11 is configured to recognize and acquire data from the solar power plant 16. The database 12 is configured to store the data acquired by the image recognizing module 11. The transmitting module 13 is configured to transmit the data stored by the database 12. The handheld device 14 is to receive the data transmitted from the transmitting module 13. The data of the solar power plant 16 is displayed by an operating interface 15 of the handheld device 14. The data of the solar power plant 16 can be compared with the historical data of the solar power plant 16 or the data of the solar power plant 16 can be compared with the data of at least one other solar power plant (N≧1, where N is amount of other solar power plants) close to the solar power plant 16, so the manager can understand the working status of the solar power plant 16 according to a data comparison result. The data comparison result is to determine whether the solar power plant 16 is working properly or not.

Pictures of the solar power plant 16 or components of the solar power plant 16 are taken by the handheld device 14, and the image recognizing module 11 can recognize data (such as inclined angles, azimuths, brands, models, specifications, building heights, and so on) of the solar power plant 16 or the components of the solar power plant 16. In addition, the handheld device 14 can take the pictures of the data of the solar power plant 16 or the components of the solar power plant 16 to recognize the data and upload the recognized data to store in the database. For example, the handheld device 14 takes the pictures on a display panel or a data display screen of an inverter of the solar power plant 16, and the image recognizing module 11 recognizes data (power generation information such as voltages, currents, thousand watts, thousand watts per hour (kWh), and so on) on the pictures of the display panel or the data display screen and transmits the data to store in the database 12.

The database 12 is configured to store or organize data. The data of the solar power plant 16 can be stored, updated or deleted through the database 12. The manager can perform data processing (such as data organizing or classifying) for the data of the solar power plant 16 in the database 12 to acquire the specific data of the solar power plant 16. For example, by the operating interface 15, the manager can perform different kinds of comparisons for the annual power generation efficiency of the solar power plant to understand if the power generation efficiency of the solar power plant is abnormal. The manager can diagnose the solar power plant 16 properly in accordance with the historical data or current status of the normal power plants, and notify local staffs by phone to manage or troubleshoot. The transmitting method of the data performed by the transmitting module 13 can be wired or wireless, but it is not limited herein. The handheld device 14 can be a smart phone, a tablet and so on, but it is not limited herein. The operating interface 15 can be software installed in the handheld device 14 or displayed by a browser and the manager can input a web address or an IP (Internet Protocol) address to display the operating interface 15 in the handheld device 14. The manager can display the data of the solar power plant 16 by the operating interface 15 on the handheld device 14, and the data of the solar power plant 16 at different time can be compared.

In the embodiment of the present invention, the mobile diagnosis system 10 for the solar power plant further includes a location detecting module 17. The location detecting module 17 is configured to obtain a position of the solar power plant 16. The location detecting module 17 can be a GPS (Global Positioning System), a compass or any orientation positioning tools, but it is not limited herein. The location detecting module 17 is installed in the handheld device 14. After the location of the solar power plant 16 is received, the operating interface 15 can be used to find out if there is any similar power plant close to this location. The power generating data between the solar power plant 16 and the adjacent power plants can be compared to understand if any difference of the power generation status or the power generation efficiency exists between the solar power plant 16 and the adjacent power plants. Moreover, if the image recognizing module 11 cannot recognize the data of the solar power plant 16 from the pictures taken, the manager can manually input the data of the solar power plant 16 from an input module 18 into the operating interface 15. For example, the manager can manually recognize the pictures, search from the database 12 or recognize the data by eyes. When the data is confirmed, the data is manually inputted in the handheld device 14. The operating interface 15 can be used to transmit the inputted data by the transmitting module 13 and store the data in the database 12.

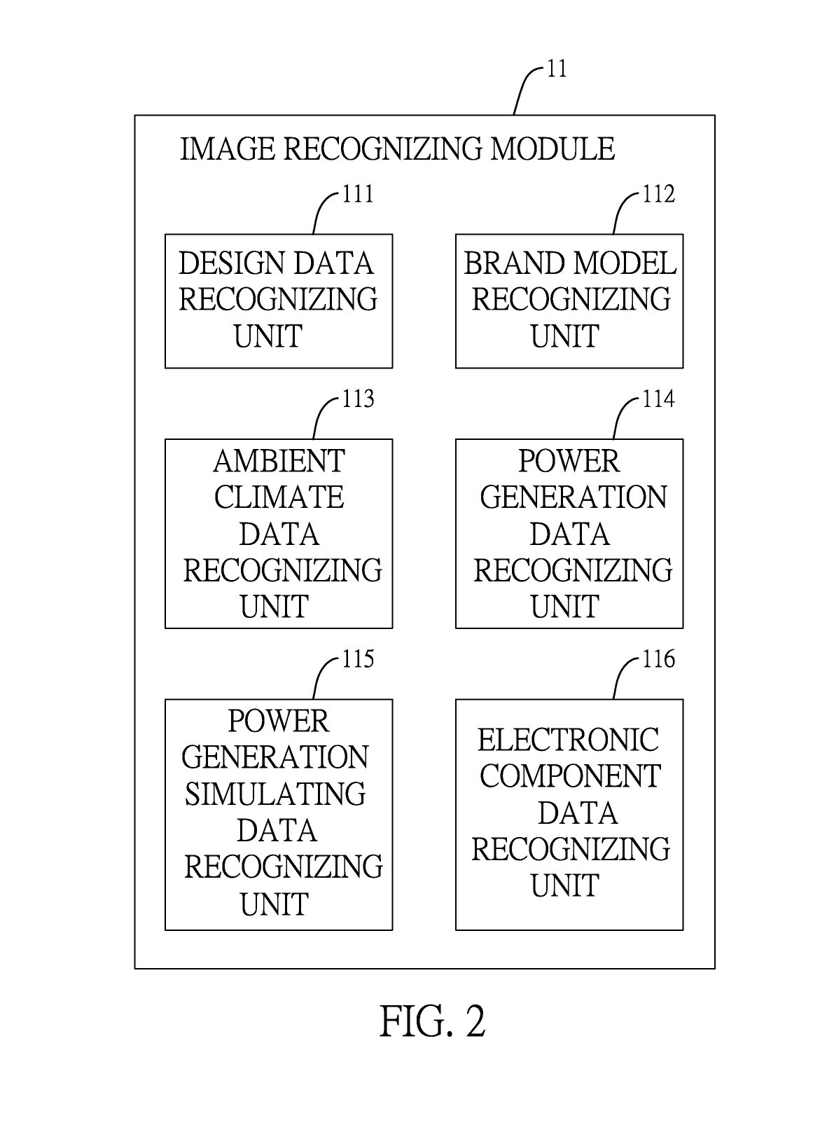

FIG. 2 is a block diagram of the image recognizing module in the embodiment of the present invention. As shown in FIG. 2, the image recognizing module 11 includes a design data recognizing unit 111, a brand model data recognizing unit 112, an ambient climate data recognizing unit 113, a power generation data recognizing unit 114, a power generation simulating data recognizing unit 115 and an electronic component data recognizing unit 116.

The design data recognizing unit 111 recognizes architecture or design data (such as orientation, inclined angles of the module, azimuths, intervals of arrangement of the module array, heights of the modules, distance from the road, shadow area and so on) of the solar power plant 16. Those data is acquired and recognized through the pictures taken from design drawings (such as one-line diagrams, circuit diagrams, floor layouts, riser diagrams and so on) of the solar power plant 16, coordination data from the location detecting module 17 or data from three dimensional simulating software by the design data recognizing unit 111 of the image recognizing module 11. Those data is stored in the database 12 or imported into CAD, PDF, SKECH UP diagram or any other electronic file formats, and it is not limited herein.

The brand model recognizing unit 112 recognizes brand names, models and so on in the components of the solar power plant 16. The component of the solar power plant 16 can be a module, an inverter, a transformer, a cable, a fuse, a diode, a surge absorber, a breaker and so on, but it is not limited herein. The brand model data recognizing unit 112 is to recognize the brand name or the model number of the components from the pictures of the components taken by the handheld device 14 and the recognized data is transmitted to store in the database 12.

The ambient climate data recognizing unit 113 is to recognize the ambient climate data of the solar power plant. The climate data can be sunshine, temperature, wind speed, air pressure, wind direction, spectrum, humidity, and so on, but it is not limited herein. The ambient climate data of the solar power plant can be acquired from the picture of equipment or a meter (such as a sunshine recorder, a thermometer, an anemometer, a pressure meter, a hygrometer and so on). The ambient climate data recognizing unit 113 recognizes the data from the pictures of the equipments and transmits the recognized data to store in the database 12. Alternatively, the ambient climate data can be acquired from a weather bureau or website after the location detecting module 17 detects the location coordination of the solar power plant 16.

The power generation data recognizing unit 114 recognizes the power generation data of the solar power plant 16 and the solar power data can be DC power data (such as voltage (V), current (I), thousand watts (kW), thousand watts per hour (kWh), power per unit device (kWh/kWp) or power generation efficiency of the solar power device (kWh/kWp/h)) or AC power data (such as voltage (V), current (I), thousand watts (kW), thousand watts per hour (kWh), power per unit device (kWh/kWp) or power generation efficiency of the solar power device (kWh/kWp/h)), but it is not limited herein. The power generation data of the solar power plant 16 can be acquired from the pictures of the screen or meter of the components, such as the inverter, the power meter or the transformer, of the solar power plant 16. The power generation data recognizing unit 114 recognizes the data on the pictures and transmits the data to store in the database 12.

The power generation simulating data unit 115 is configured to recognize the power generation simulating data calculated by the power generation simulating software or device. The power generation simulating data can be DC power data (such as voltage (V), current (I), thousand watts (kW), thousand watts per hour (kWh), power per unit device (kWh/kWp) or power generation efficiency of the solar power device (kWh/kWp/h)) or AC power data (such as voltage (V), current (I), thousand watts (kW), thousand watts per hour (kWh), power per unit device (kWh/kWp) or power generation efficiency of the solar power device (kWh/kWp/h)), but it is not limited herein. When the data, such as design data, equipment data or climate data, is inputted from the image recognizing module 11 or by man power, the handheld device 14 can automatically simulate the power generation data or the handheld device 14 can recognize the data on the pictures after taking the pictures of the calculating result from the power generating simulating software or device, and the data is transmitted and stored in the database 12. The power simulating software can be PV sys, PV SOL or any other simulating software of the solar power plant, but it is not limited herein.

The electronic component data recognizing unit 116 is configured to recognize the component's temperature (such as temperature at the module, inverter, breaker, diode, fuse, terminal base, cable, DC box, AC box and so on), the resistance (such as DC ground resistance, AC ground resistance, module serial resistance and so on), or the leakage current (such as the leakage current at the inverter, the DC plate, the AC plate, the DC terminal, the AC terminal and so on), but it is not limited herein. The handheld device 14 takes the pictures of the data of the electronic component detected by the equipment and the pictures of the data are recognized to store in the database 12.

The database 12 stores the data of the solar power plant acquired from the image recognizing module 11. The manager acquires the data from the database 12 through the operating interface 15 of the handheld device 14 and performs the data comparison. The data comparison can be the comparison between the current power generation data and the historical data, the comparison between the solar power plant 16 and the multiple adjacent power plants, the comparison between the components with similar properties in the solar power plant 16 or the comparison between the power generation simulating data. The manager can clearly understand whether the difference between the historical power generation data of the solar power plant 16 and the instant power generation data of the solar power plant 16 exists. If the difference exists or the difference is too large, the manager can notify the staffs in the solar power plant to perform troubleshooting or maintenance.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A mobile diagnosis system for a solar power plant, comprising:
an image recognizing module configured to recognize a plurality of data of the solar power plant;
a database configured to store and organize the plurality of data;
a transmitting module configured to transmit the plurality of data;
a handheld device configured to receive the plurality of data; and
an operating interface installed in the handheld device and configured to display and compare the plurality of data to determine a working status of the solar power plant.

2. The mobile diagnosis system for the solar power plant as claimed in claim 1, wherein the image recognizing module includes a design data recognizing unit configured to recognize a plurality of design and architecture data of the solar power plant.

3. The mobile diagnosis system for the solar power plant as claimed in claim 1, wherein the image recognizing module includes a brand model data recognizing unit configured to recognize a brand name and model for at least one component of the solar power plant.

4. The mobile diagnosis system for the solar power plant as claimed in claim 1, wherein the image recognizing module includes an ambient climate data recognizing unit configured to recognize an ambient climate data of the solar power plant.

5. The mobile diagnosis system for the solar power plant as claimed in claim 1, wherein the image recognizing module includes a power generation recognizing unit configured to recognize a power generation data for the solar power plant or a plurality of power generation components of the solar power plant.

6. The mobile diagnosis system for the solar power plant as claimed in claim 1, wherein the image recognizing module includes a power generation simulating data recognizing unit configured to recognize a power generation data calculated by a power generation simulating software or device.

7. The mobile diagnosis system for the solar power plant as claimed in claim 1, wherein the image recognizing module includes an electronic component data recognizing unit configured to recognize a data related to component temperature, resistance, or leak current of the solar power plant.

8. The mobile diagnosis system for the solar power plant as claimed in claim 1 further comprising a location detecting module configured to detect a location data related to a coordination and direction of the solar power plant and store the location data in the database.

9. The mobile diagnosis system for the solar power plant as claimed in claim 1 further comprising an input module, wherein the plurality of data can be manually inputted from the input module.

10. A mobile diagnosis system for a solar power plant, comprising:
an image recognizing module configured to recognize a plurality of data of the solar power plant and including:
a design data recognizing unit configured to recognize a plurality of design and architecture data of the solar power plant;
a brand model data recognizing unit configured to recognize a brand name and model for at least one component of the solar power plant;
an ambient climate data recognizing unit configured to recognize an ambient climate data of the solar power plant;
a power generation recognizing unit configured to recognize a power generation data for the solar power plant or a plurality of power generation components of the solar power plant; and
an electronic component data recognizing unit configured to recognize a data related to component temperature, resistance or leak current of the solar power plant;
a database configured to store and organize the plurality of data;
a location detecting module configured to detect a location coordination and orientation data of the solar power plant and store the location coordination and orientation data in the database;
a transmitting module configured to transmit the plurality of data;
a handheld device configured to receive the plurality of data; and
an operating interface installed in the handheld device and configured to display and compare the plurality of data to determine a working status of the solar power plant;
wherein the plurality of data of the solar power plant is acquired by the operating interface of the handheld device and the plurality of data is compared with a plurality of raw data of a plurality of adjacent solar power plants or a historical power generation data of the solar power plant.
